(19) United States
(12) Patent Application Publication
(10) Pub. No.: US 2026/0366479 A1
(43) Pub. Date: Nov. 19, 2026

(54) Multiple Energy Source System

(71) Applicants: David Thomas Ma, Castle Rock, CO (US); Yongsheng Ma, Castle Rock, CO (US)

(72) Inventors: David Thomas Ma, Castle Rock, CO (US); Yongsheng Ma, Castle Rock, CO (US)

(21) Appl. No.: 19/208,632

(22) Filed: May 15, 2025

(51) Int. Cl. F02N 11/08

(52) U.S. Cl. CPC F02N 11/0866; F02N 11/087; F02N 2011/0874; F02N 2011/0877; F02N 2011/0888

(57) ABSTRACT

The presently disclosed embodiments relate generally to a multiple power source system for engine equipped machinery, vehicles, boats, airplanes, generators, etc. With one isolated power source to exclusively provide cranking current to the electric motor of starter at engine start-ups; another power source to supply for the electrical system, and a backup energy source.

### CROSS REFERENCE TO RELATED APPLICATIONS

This application is a Non-Provisional Application of U.S. Provisional Patent Application No. 63/648,193, entitled “A Multiple Energy Source System” filed May 16, 2024, therefore, this application claims the priority of above said Provisional Patent Application No. 63/648,193.

### FIELD OF THE INVENTION

The present description is generally related to a multiple power source system for any equipment with an engine, such as motor vehicles, boats, airplanes, generators, etc., more specifically, it relates to an energy system comprising at least three energy sources, capable of providing cranking energy for engine starting ups, supplying power to the electrical system, and a back-up power source.

### BACKGROUND OF THE INVENTION

The background description herein is intended to provide a background of the context of the present disclosure, aspects of the description that may not otherwise qualify as prior art at the time of filing, are neither expressly nor impliedly admitted as prior art against the present disclosure.

In most conventional vehicles and engine equipped machinery, airplanes, boats, generators, one set of energy system, consisting of one or more 12-volt batteries is generally utilized, said single set battery system not only supplies high cranking current to crank the electric motor of the starter at engine start-ups; but also supplies electrical power to the whole electrical system of the vehicle.

On some heavy commercial vehicles such as long-haul trucks, especially in North America, a dual battery system is utilized, one bank of batteries is specifically reserved for the critical operations of the vehicle, like cranking the engine at engine start-ups; and another bank of batteries is used to power other electrical appliances of the vehicle.

However, more and more patents covering the use of dual power sources for vehicle engine system are coming up, mostly relate to an independent power source, isolated from the vehicle battery, is utilized to assist the battery of the vehicle for better engine starting-up performances and system reliability.

Like U.S. Pat. No. 9,666,379B2, entitled “Nickel Super capacitor Engine Starting Module”, granted to Saft America, filed on Mar. 13, 2015; U.S. Pat. No. 9,816,475B1, entitled “System and Method for Maximizing Short-Term Energy Storage in a Super capacitor Array for Engine Start Applications”, granted to Cooper Technologies Company, filed on May 11, 2016; U.S. Pat. No. 10,023,065B2, entitled “Electrical System Enhancer”, granted to Smart Start Technology PTY, Ltd., filed on Nov. 25, 2014, and U.S. Pat. No. 18,399,801, entitled “Isolated Energy Source for Engine Start Applications”, filed on Dec. 29, 2023.

The above-mentioned inventions and other references utilize an extra power source, generally isolated from the original battery, as an assisting or exclusive power source in engine start-ups.

Since the space on the engine equipped system for battery installation is usually limited, a disadvantage of above arrangements is that with said isolated power source is utilized to crank an engine, the system battery, which is still used to power the system electrical appliances, may be considerably smaller in size than the original battery.

However, said batteries'performance gradually deteriorates over time due to frequent discharge and charge cycles, till an unexpected sudden failure occur during operation of the vehicle, so to prevent unexpected battery failure in operation, which may be of very high costs for the operators, especially involve in time sensitive or temperature sensitive goods, such as reefer container carriers or commercial long distance trucking operators, to avoid possible unforeseen loss caused by sudden battery failure, it is desirable for the operators to change batteries even the batteries are still in good shape and still can work for a long time, some companies may change the battery on reefer generator in every 6 months, and starting batteries of trucks in every two years, which causes a huge waste and is costly to the operators.

To address the above said disadvantage in prior arts, the present invention provides an improved multiple power source system and engine start method for superb starting performance and better power management with increased reliability, so to solve deficiencies of the prior arts.

The above discussion of the prior arts is not an admission that any information discussed therein is citable prior art or part of the common general knowledge of persons skilled in the art, and further advantageous embodiments of the invention are evident from the dependent claims.

### SUMMARY OF THE INVENTION

It should be understood that the summary provided here is to briefly describe concepts of present invention, not intended to limit the scope of the claimed subject matter of the invention, which is defined solely by the claims attached thereto, the beneficial objects of the present invention are achieved by providing a method and a system as described herein.

Although the exemplary embodiments of the multiple power source system and methods described herein in this disclosure will primarily be implemented in a vehicular context, but they are not limited only to vehicular applications, the concepts provided herein may also be implemented with or within starting systems on boats, airplanes, generators, reefer containers, or any other systems with battery and starter systems.

One preferred embodiment of the present invention disclosed here employs at least three independent power sources, isolated from each other, with the first power source to be connected to the power supply terminal B of the solenoid of the starter of an engine to provide high current output to crank the engine at start-ups; the second power source or the third energy source may be selectively electrically connected to the rest of electrical system of the engine by one or more switchable devices. The above said first energy source may be connected to the second power source or the third energy source by a diode or into the electrical system of the vehicle upon engine starting by a charging circuit.

So before engine starts, the second energy source may supply power to the electrical system, and at engine start-ups, when the coils of the starter solenoid are energized, cranking current to the electric motor M of the engine starter is exclusively provided by energy stored in the first power source, the only high current discharging for the second energy source is to energize the coils of starter solenoid.

In the above preferred embodiment of the present invention, since the engine cranking current is exclusively provided by the first isolated power source, there is no more high current output required for the second energy source at engine start-ups, without high current discharge, a smaller battery may be utilized as the second energy source and the engine can still be successfully started.

After the engine starts, the engine driven alternator will provide current to the electrical appliances of the vehicle, and to charge the second energy source, the first energy source will be charged through above said diode when the voltage of said second energy source is higher than the first energy source; or the first energy source may be connected into the electrical system when the above said charging circuit is closed when a signal is sent to the switching device of the charging circuit.

In one preferred embodiment of the present invention, above said charging circuit of the first power source may comprise a diode connected to the second power source, recharging of the first power source may be achieved when the system voltage is higher than the voltage of the first power source.

In one preferred embodiment of the present invention, said charging circuit of the first power source may comprise a normal open switching device, recharging of the first power source is controlled by the activation of said switching device. Said switching device may include, but not limited to any of the following controllable electronic switches, like contactor, relay, magnetic switch, solid state switch, magnetic latching switch, MOSFET, transistor, however, depending on the field of application, any electrically activated switching device with various circuit configurations are possible, as long as it can be activated by an electrical signal.

As the space for battery installation is usually limited on a vehicle, the second energy source may be smaller in size than the original battery, to prevent unexpected engine starting failure in case of the second energy source being drained too low to energize the coils of starter solenoid, above said third energy source may be utilized as a back-up battery, in one preferred embodiment of the present invention, said switchable devices may comprise one or more mechanical switches like a double pole knife switch or two knife switches to switch either the second or the third energy sources into engine electrical system.

In one preferred embodiment of the present invention, for easy access and remote control of said energy sources, above said switchable device may comprise one or more electronic switching devices, such as magnetic latching relays and associated control circuits, which can provide much better installation flexibility and ease of remote operation.

The control of the charging circuit of the first energy source is basically the same as described in U.S. patent application Ser. No. 18/399,801, entitled “Isolated Energy Source for Engine Start Applications”, and filed on Dec. 29, 2023.

In one preferred embodiment of the present invention, said signal line of the switching device of the charging circuit of the first energy source may be connected to a power supply line or control wire of the fuel pump or fuel pump relay of the engine, preferably with a timer relay, so the switching device will be closed and to be opened by said fuel pump or fuel pump relay's running status, and the charging circuit may be activated after the engine is on and running after a predefine period of time, or be deactivated when the engine is off.

In one preferred embodiment of the present invention, said signal line of the switching device of the charging circuit may be connected to an independent relay or switching device, preferably with a timer relay, which may be turned on or off by change of status of one or more variable parameters of the vehicle, such as a pressure switch, vacuum pressure switch, a reed switch, a magnetic switch, etc. The switching device is to be closed when engine is on after a predefined period of time, and to be opened when engine is off, so said control end of the charging circuit may be activated on or off by the parameter variables of the vehicle, such parameter variables includes, but not limited to engine oil pressure, vacuum pressure, magnetic strength, etc.

In one preferred embodiment of the present invention, said signal line of the switching device of the charging circuit may also be connected to an independent control unit or controller, said controller may further includes at least one sensor for monitoring one or more vehicle operating parameters, includes, but not limited to sound, vibration, oil pressure, vacuum pressure, rpm, voltage, charging current of electrical system, etc., said sensor is connected to a device or part of the vehicle to detect the above said vehicle operating parameters, so by determining when the one or more operating parameters meet one or more predefined values indicative of engine running status, said controller may be configured to detect the on/off status of the engine for selective actuation of the switching device, when the one or more monitored vehicle operating parameters is greater than or equal to the one or more predefined values, indicating the engine is running, said switching device is closed, so to independently and operatively control the first energy source for selective and respective connection/isolation to/from the electrical system or vehicle battery; and thereby allowing the alternator to recharge both first and second power sources; and the controller also ensures to turn the switching device open again when the engine is shut off, the first power source may remain sufficiently charged and maintain its relatively higher voltage once isolated from the electrical system.

In certain embodiments, the charging circuit of the first power system may comprise a DC-DC converter, so the two power sources may be of different voltages, for example, the second energy source may be 12 volts, and the first energy sources may be 24 volts, so the engine may use a 24 volts starter motor on a 12 volts engine and alternator system, which may be especially desirable for some applications, which may use lighter motor, light wires and cables, which reduces the weight and size constraints imposed by many conventional vehicle battery and electrical systems.

In one preferred embodiment of the present invention, said first energy source may comprise a plurality of energy cells, like lithium ion battery cells, lithium titanate (LTO) battery cells, capacitors, super capacitor cells, which are considerably smaller in size than ordinary acid-lead batteries; and the third energy source may also be a small size chemical storage battery since it is usually used as a backup battery for emergency replacement, because of their small sizes, in one preferred embodiment of the present invention, the multi energy source system may be encapsulated in a single housing, or any single one of the energy source may be encapsulated in a single housing; or any combination of above said energy sources may be encapsulated in a single housing, such as the first and third power source may be encapsulated in a single housing, for example, such as a combination of a lithium titanate (LTO) battery pack, or a super capacitor pack and a chemical storage battery enclosed in a housing, to be easily retro-fitted to the existing engine system without sophisticated modification, the physical dimensions of the housing or enclosure of the above said power systems may be designed to be smaller than the existing standards dimensions of conventional batteries for easy installation, and may be located at different spots of the vehicle.

In one preferred embodiment of the present invention, said energy cells of each of said multiple power source system may be configured in series, in parallel, or in any matrix combination connected in series and in parallel for different operational voltages and ampere ratings in accordance with the engine parameters, such as 6 volt systems, 12 volt systems, 24 volt systems, 36 volt systems, 48 volt systems, and other operating system voltages, and the specific quantity of energy cells, or other components described in the systems herein are for illustrative purposes only.

In one preferred embodiment of the present invention, when encapsulated in a single housing, there may be at least two positive output terminals (posts) on the out surface of the above said housing, the first positive output terminal (post) is connected to the positive end of the super capacitor pack; and the second positive output terminal (posts) is connected to the switchable device connecting either the second or the third energy source. The positive terminal of the third energy source may be connected to one pole of the switchable device, the other pole of said switchable device is connected to the positive terminal of the second energy source, so the second and third energy source are interchangeable by above said switchable device.

By the above configuration, the positive terminal of the first energy source is to be connected to the power supply terminal of engine starter's solenoid, so to provide brief high current each time the solenoid is activated by the ignition switch of the engine; and the second or third energy source generally supplies power to electrical loads while engine is off.

According to some embodiments of the present invention, said multiple power source may comprise one or a plurality of sensors and display devices, said display is operatively to display the information collected by said sensor, such as voltage level, state of charge or energy storage level of the energy sources of said multiple power source.

In one preferred embodiment of the present invention, the charging circuit of the first power source may further comprise a manual switch, said manual switch may directly activate and deactivate said switching device of the charging circuit of the first energy source.

According to some embodiments of the present invention, said multiple power source may comprise a remote control, which is installed for easy access for the operator to remotely control said switching devices.

In one preferred embodiment of the present invention, said multiple power source system may further comprise a solar panel and charging circuit to charge each of the energy sources of the system.

According to some embodiments of the present invention, the energy sources of said multiple power source system may further comprise an over charge protection and charging balance circuit, including one or more current limiting devices, like resistors, fuses, resettable fuses, circuit breakers, so the charge of cells of the multiple power source system is controlled by said balancing circuit.

An advantage of the present invention is that the starting performance of the engine may be considerably improved, for example, even small in size, lithium titanate batteries possess high discharge rate as high as 100 C to 150 C, and have a life cycle tens of time of over conventional Pb-acid batteries; another exemplary first energy source may comprise a super capacitors pack, which may have over a millions times of charge-discharge cycles, and the output performance of above said energy source will not deteriorate even under temperature as low as minus 40 Celsius degree; the power system may provide superb starting performance at cold-start application, especially under extremely low temperatures.

An advantage of the present disclosure is that it provides superb starting performance with guaranteed stability.

Another advantage of the present disclosure is it basically eliminates the need to change batteries for precaution reasons and may take full advantage of the service life of batteries, said multiple energy source system ensures ease of mind to operators with a backup battery onboard, the operators may only need to change batteries until they are completely exhausted, and there are no more worries about being stuck on the road because of a dead battery.

Another advantage of the present invention is that the multiple energy source system allows combinations of different kinds of power sources like lithium-ion batteries, super capacitor cells, acid-lead batteries, etc., for different applications, which may be highly valuable to special equipment used under extreme conditions, like heavy equipment, machinery, military vehicles, etc.

The terms and expressions that have been employed in the foregoing specification are used as terms of description and not of limitation. There is no intention, in the use of such terms and expressions, of excluding equivalents of the features shown and described or portions thereof, it being recognized that the scope of the invention is defined and limited only by the claims which follow.

The foregoing above objectives, technical effects, features and advantages of the present disclosure will be more readily understood/apparent from the following detailed description of the preferred embodiments with the accompanying drawings.

It should be understood that the summary provided here is to briefly describe concepts of present invention, is not intended to limit the scope of the claimed subject matter of the invention, which is defined solely by the claims attached thereto, the beneficial objects of the present invention are achieved by providing a method and a system as described herein.

### BRIEF DESCRIPTION OF THE DRAWINGS

With reference to the annexed drawings, the preferred embodiments of the invention are herein described by way of example only, embodiments of the present invention, further aspects and advantages of the present invention will become readily apparent and be better understood to those skilled in the art, however, it is noted that the particulars shown are for illustrative purposes only, not by way of limitation.

In the following detailed description, like reference numerals and characters may be used to designate identical, corresponding, or similar components in differing drawing figures. Furthermore, example sizes/models/values/ranges may be given. In circuit diagrams well-known power and ground connections, and similar well-known elements, may be omitted for the sake of simplicity of illustration.

### IN THE DRAWINGS

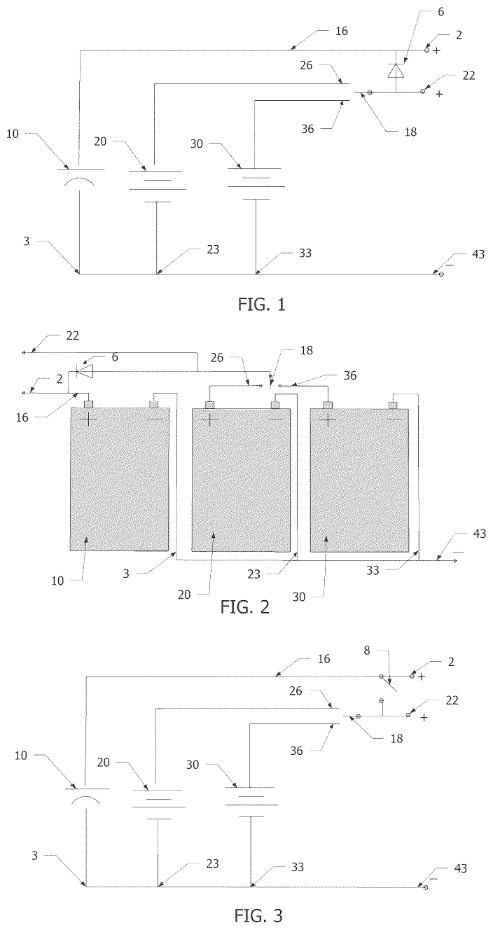

FIG. 1 and FIG. 2 illustrated schematic diagrams of a multiple energy source system in accordance with an embodiment of the present invention, comprising at least three energy sources and the charging circuit of the first energy source comprising at least one diode.

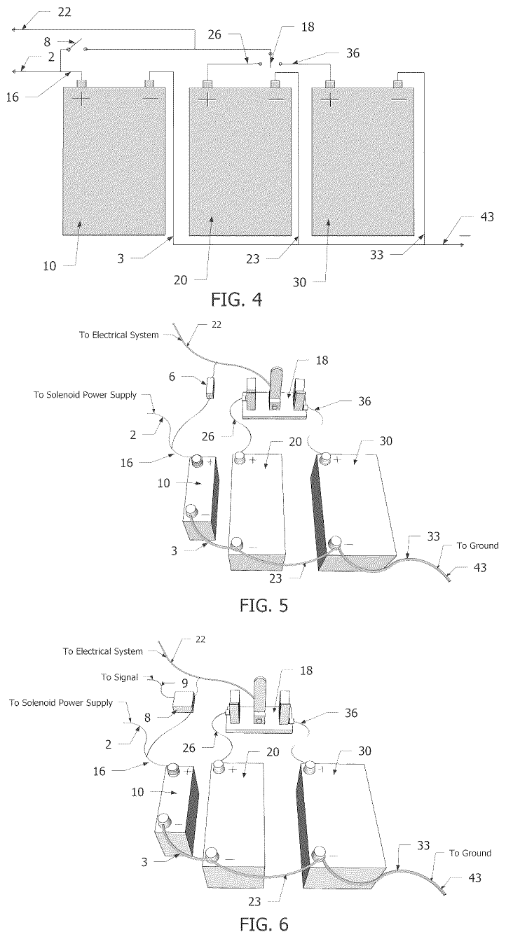

FIG. 3 and FIG. 4 are schematic diagrams of a multiple energy source system in accordance with an embodiment of the present invention, comprising at least three energy sources and the charging circuit of the first energy source comprising a switching device.

FIG. 5 and FIG. 6 illustrate embodiments of a multiple energy source system, it depicts the installation of the multiple power source system on an engine system and connection method.

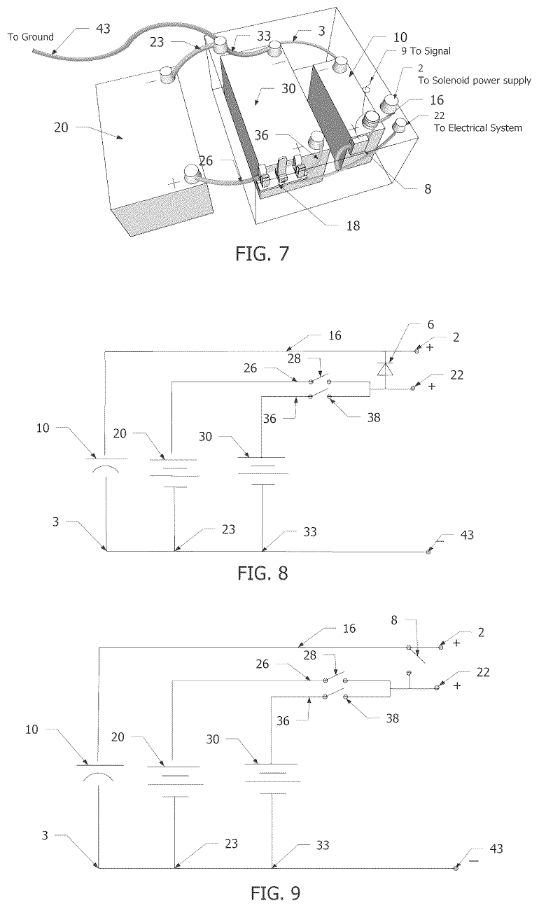

FIG. 7 illustrates an embodiment of a multiple energy source system, it depicts the first and third energy sources are enclosed in a single housing, including at least two positive terminals, one negative terminal located on the outer surface of the housing.

FIG. 8 is a schematic diagram of a multiple energy source system in accordance with an embodiment of the present invention, the charging circuit of the first energy source comprising at least one diode and other two energy sources may connect to electrical system through two switching devices.

FIG. 9 is a schematic diagram of a multiple energy source system in accordance with an embodiment of the present invention, the charging circuit of the first energy source comprising a switching device, and other two energy sources may connect to electrical system through two switching devices.

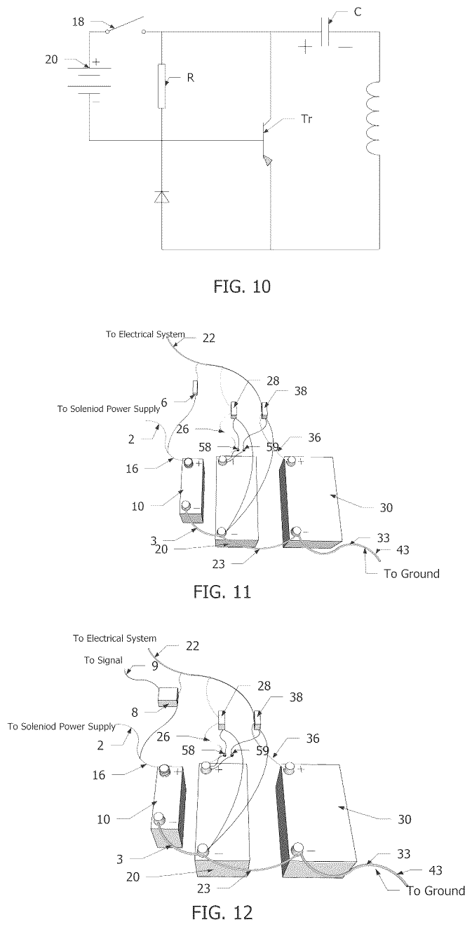

FIG. 10 is a schematic diagram of a control circuit of magnetic latching relays.

FIG. 11 illustrates an embodiment of a multiple energy source system, it depicts the installation of the multiple power source system on an engine system and control method of a diode and two switchable devices.

FIG. 12 illustrates an embodiment of a multiple energy source system, it depicts the installation of the multiple power source system on an engine system and control method of switchable devices.

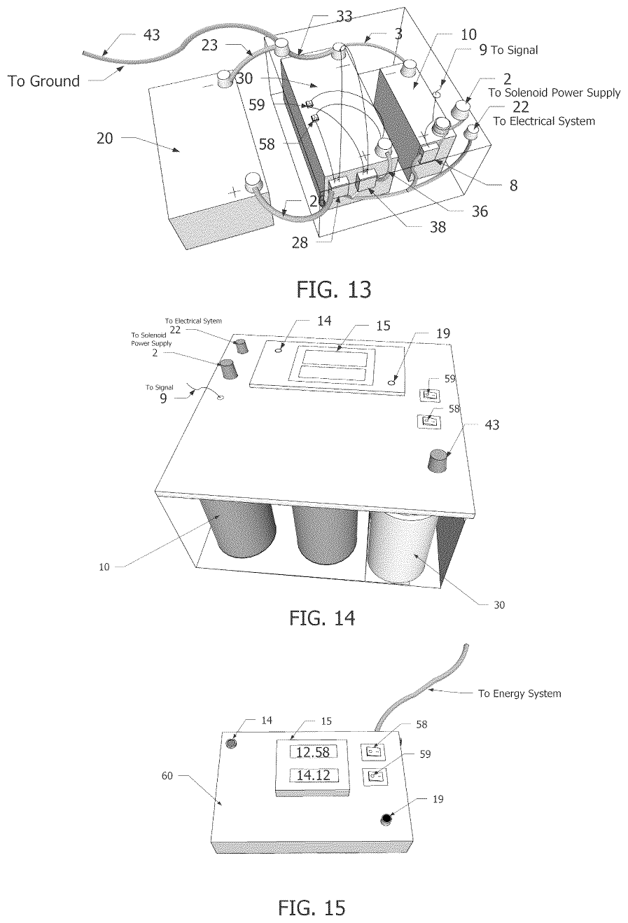

FIG. 13 illustrates an embodiment of a multiple energy source system, it depicts the first and third energy sources being enclosed in a single housing, including switching device and their control methods.

FIG. 14 illustrates an embodiment of an exemplary embodiment of the present invention, it depicts all the energy sources of the multiple energy sources system are enclosed in a single housing, and comprising a status indicator, energy meter display, and multiple controls.

FIG. 15 illustrates an embodiment of an exemplary embodiment of the present invention, comprises an indicator, an energy meter display, and multiple controls integrated into a housing and remotely connected to said exemplary multiple power source system.

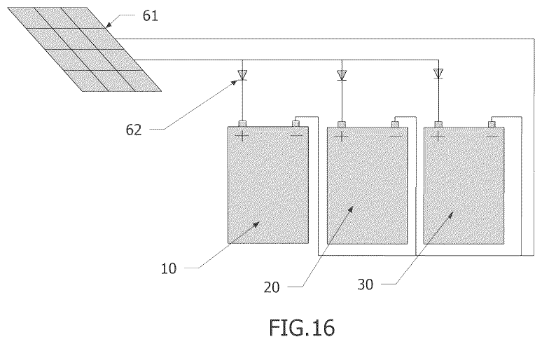

FIG. 16 illustrates an embodiment of an exemplary embodiment of the present invention, comprises a solar panel and circuit to charge said exemplary multiple power source system.

### IN THE FIGURES

2. Positive output terminal of first isolated energy source 10.
3. Cable connecting negative terminal of first isolated energy source 10.
6. Diode of charging circuit of first energy source 10.
8. Switching device of charging circuit of first energy source 10.
9. Signal line of switching device 8 of charging circuit.
10. First isolated energy source.
14. Status indicator of switching device 8.
15. Energy level indicators.
16. Cable connecting positive terminal of first isolated energy source 10.
18. Switchable device between energy source 20 and 30.
19. Manual switch.
20. Second isolated energy sources.
22. Positive output terminal to electrical system.
23. Cable connecting negative terminal of second isolated energy source 20.
26. Cable connecting positive terminal of second energy source 20.
28. Switching device between energy source 20 and output 22.
30. Third isolated energy source.
33. Cable connecting negative terminal of third isolated energy source 30.
36. Cable connecting positive terminal of third isolated energy source 30.
38. Switching device between energy source 30 and output 22.
43. Negative terminal of energy source system.
58. Control Switching of switching device 28.
59. Control Switching of device 38.
60. Remote control box.
61. Solar panel.
62. Diodes connecting solar panel and energy sources.

### DETAILED DESCRIPTION OF PREFERRED EMBODIMENTS

The foregoing above objectives, technical effects, features and advantages of the present disclosure will be more readily understood/apparent from the following detailed description of the preferred embodiments with the accompanying drawings.

The foregoing functions and advantages, as well as other features and advantages of the present disclosure, will be illustrated and described in details herein below, with appropriate reference to the accompanying drawings.

The following implementations of preferred embodiments will be described in details to assist those skilled in the art to practice exemplary embodiments, and it is to be understood that various changes, modification, and equivalents of the methods, apparatuses, and/or systems embodiments may be utilized without departing from the scope and spirit of embodiments described, other embodiments may be derived from the embodiments given herein without making any creative effort, so it should be appreciated that principles of the invention shall applicable to all embodiments that fall within the protection scope of the following claims of the present invention.

The present invention provides a multiple energy source system and control methods to solve deficiencies of the prior arts. The embodiments of the systems and methods for managing the multiple energy system described herein may be mainly implemented in a vehicular context, but they are not limited to applications on vehicles, the embodiments herein can also be implemented to other applications, such as starting systems on boats, airplanes, generators or other engine systems.

In the illustrated embodiment, as shown in FIG. 1, said multiple energy source system includes a positive output terminal 2 and a positive output terminal 22, a diode 6 may be utilized to connect the first energy source to terminal 22, and a double pole switching device 18 may be utilized to selectively electrically connect either of the two energy source 20 and 30 to terminal 22, and all the negative terminals of three energy sources 10, 20 and 30 may be connected together to form a negative terminal 43.

Also as shown in FIG. 2, a non-limiting exemplary embodiment of the present invention is described, which depicts a structure of a multiple power system, said power system comprises of at least three energy sources 10, 20, and 30, each energy source may comprise of one or a plurality of energy cells connected to each other within a housing, said energy source 10 includes at least one positive output terminal 2, which is to be connected to a load, such as to the power supply terminal B of the solenoid of an engine starter, so to exclusively provide current to the starter motor M at engine starts; each of said energy system 10, 20 and 30 also includes at least one negative cable 3, 23 and 33 which are directly electrically connected to the negative terminal 43 of the energy system.

As shown in FIG. 3 and FIG. 4, the structure of the multiple energy system is basically the same with FIG. 1 and FIG. 2, except that the diode 6 is replaced by a switching device 8, and a double pole switching device 18 may be utilized to selectively electrically to couple either the second 20 or the third energy source 30 to output terminal 22.

It should be noted that the energy sources illustrated in the above FIG. 1-FIG. 4 are capacitors and batteries, but those are for illustrative purposes only, they may be any of various energy storage devices or batteries, such as super capacitors, lithium-ion batteries, or lead-acid batteries, etc.

Above said power source 10 comprises a charging circuit, which may comprise a diode 6 illustrated in above FIG. 1 and FIG. 2, or at least one switching devices 8 such as a relay, a contractor, a switching device, a DC-DC converter, or any combination of similar devices connected to power source 20 or 30 illustrated in the above FIG. 3 and FIG. 4, above said diode 6 allows one direction charging from energy source 20 or 30 to the first energy source 10; or said devices 8 is to be configured to normally isolate the said energy source 10 from other power sources, and can be triggered on and off by a signal in response to various conditions of the engine system, so said charging circuit can be turned closed after the engine is up and running, and turned open while engine is off.

As depicted in FIG. 5, a non-limiting exemplary embodiment of the present invention will now be described, which depicts how the said multiple power system to be connected to an existing vehicle system, just reconnect the cable of the power supply terminal B of the solenoid (relay, contactor, magnetic switch, or other switching devices by other names in other applications) of engine starter to said positive output terminal 2, so the first energy source 10 will exclusively provide current to the starter motor M at engine starts; the output end of diode 6 is connected to the first energy source 10, and the input end of diode 6 is connected to the cable connecting positive output terminal 22 and switching device 18.

Or, as depicted in FIG. 6, with basically the same structure, a switching device 8 is utilized, with one end of the switching device 8 is connected to the positive terminal cable 16 of first energy source 10, and another end of the switching device 8 is connected to the output cable of switching device 18, which is connected to positive output terminal 22, so energy source 30 or 20 may be selectively electrically connected to positive output terminal 22 by switching device 18 so to provide power to electrical system of the engine.

As depicted in the above figures, all the negative terminals of said energy system may connect together by cable 3, 33 and 23 to the negative terminal of 43 of the multiple energy system, which may be grounded to the frame of vehicle.

The first energy source 10 in an exemplary embodiment may comprise a pack of four Li-ion battery cells, said four Li-ion batteries are 38120 cells, and the voltage of each Li-ion battery cell is about 3.3V, so the serially connected battery pack may provide a nominal voltage about 13.2V, and 14.8V when fully charged. Even said battery pack of energy source 10 is quite small in size, only about 4 cm in width, 15 cm in height and 16 cm in length, but it will provide adequate current to successfully crank small and mid-size engines under normal temperature.

Another exemplary embodiment of energy source 10 may comprise a pack of six 3 An/H lithium titanate batteries (LTO), a fully charged LTO battery is 2.7 V, so when fully charged, the six serially connected LTO battery pack may provide a voltage around 16.2 Volts. Said pack of LTO batteries is even smaller in size, but the battery pack has a CCA as high as about 500 Amperes, which is high enough to successfully crank a 3.0-liter engine under normal conditions.

Another exemplary embodiment of energy source 10 may comprise a pack of six super capacitor cells, said six super capacitor cells are connected in series, the voltage of each super capacitor cell is about 2.7V, so the rated voltage of the super capacitor pack is about 16.2 volts, said pack of super capacitors has an even higher CCA output, a serially connected pack of six 300 farads super capacitors may provide a CCA around 2,000 Amperes, irrelevant to ambient temperatures.

In some embodiments, each super capacitor pack may comprise six super capacitor cells connected in serial, so two packs of super capacitor cells may produce as high as 4,000 amperes at engine starts, which is high enough to successfully start most truck engines even under extremely cold conditions.

With the above configuration of previously described embodiments, since there is no more high current output required for system battery, smaller and lighter batteries may still provide adequate power to the electrical loads of a vehicle as well, so it may be desirable to utilize smaller, lighter batteries such as 12 An/H or 20 An/H to in energy source 20 and energy source 30, which will still last considerably long in life cycles.

It should be noted that the li-on batteries, lithium titanate batteries, super capacitors, and Pb-acid batteries in the above exemplary embodiments are merely illustrative, integration of at least three independent power sources and taking advantage of the characteristics of various battery technologies for better performance with respective applications may provide a variety of advantages according to various exemplary embodiments.

For example, in certain embodiments, suppose the second energy source 20 supplies power to electrical system, a lithium titanate battery (LTO) pack may be utilized in energy source 10 for its small size and dimensions than that of a conventional Pb-acid battery, and energy source 20 may be a small Pb-acid battery, so the combination will be of small in size without sacrificing performance; In other embodiments, energy source 10 may be a super capacitor pack, and energy source 20 may be lithium titanate battery (LTO) pack, overall output performance reliability and significant engine starting performance still be achieved even at temperatures as low as minus 40 degree Celsius where conventional lead acid batteries may fail to function properly, which is especially valuable for operations of heavy equipment, military vehicles in extremely cold environments.

In the above exemplary embodiments of the present invention, only a few number of battery types, such as Pb-acid battery, Li-ion battery, super capacitor pack or a combination of two above said energy sources have been described, however, it should be noted that the types of energy sources and the specific quantity of energy cells, or other components described in the systems herein are merely for illustrative purposes, greater overall reliability and performance in other aspects, such as light in weight, very high peak output current, extremely long life cycles, etc., may also be achieved in other exemplary embodiments of the present invention comprising one or a plurality of any type of energy cells, includes, but are not limited to any rechargeable batteries such as Pb-acid battery, lithium ion battery cells, gel cell, Nickel Metal Hydride, nickel zinc cell, AGM, lithium titanate battery cells (LTO), LFP, LNM, NMC, NCA, LCO, capacitors, super capacitor cells, etc.

Further, according to another non-limiting embodiment of the application, the energy sources of the above said power systems comprise a plurality of energy cells arranged in series, however, said energy cells may be configured in series, in parallel, or in any matrix combination connected in series and in parallel for different operational voltages and ampere ratings, more specifically, such as 6 volt systems, 12 volt systems, 24 volt systems, 36 volt systems, 48 volt systems, and other operating voltages to fit a wide variety of applications and to suit a wide variety of voltage requirements.

Above said charging circuit of first energy source 10 may comprise at least one diode 6 illustrated in FIG. 1 and FIG. 2, or at least one switching devices 8 such as a relay, a contactor, a switching device, or any combination of similar devices illustrated in FIG. 3 and FIG. 4, with one end to be connected to energy source 10, and another end to be connected to the cable to electrical system terminal 22, said devices 8 may be configured to normally isolate the said first energy source 10 from electrical system terminal and other energy sources, and be triggered on and off by a signal sent to the signal line 9 of the switching device 8 in response to various conditions of the engine system, so said charging circuit can be turned closed after the engine is up and running, and turned open while engine is off, so the first energy source 10 will be selectively electrically connected into vehicle's electrical system in parallel by the activation of said switching device 8.

According to some embodiments of the present invention, above said charging circuit of first energy source 10 may also include a DC-DC converter, so the energy sources 10 may be charged to a voltage level different than the voltage of a power supply to keep each energy cell of the power sources fully charged; or the DC-DC converter may be configured to charge the first energy source 10 to other voltage ratings, such as to charge to 24 volt, 36 volt on a 12 volt alternator system. And said switching device 8 or DC-DC converter of said charging circuit may comprise a control end or a signal line 9 so said switching device 8 or DC-DC converter may be activated/deactivated by a signal sent to the signal line 9.

Above said switching device 8 of the charging circuit of the first energy source 10 may not be necessarily implemented by one or more relays or contactors, but may also be implemented by any other types of controllable electronic switching devices such as actuating coils, solid state relays, magnetic switches, solid state switches, magnetic latching switches, MOSFET, transistors, diodes, FETs, DC to DC converters, etc., depending on the field of application, any electrically activated switching device or alternatively similar devices or combination of similar devices with various circuit configurations are possible, as long as it can be activated by an electrical signal.

Above said energy source system also comprises a switchable device 18, which may comprise a mechanical switch such as a double pole knife switch illustrated in FIG. 5 and FIG. 6, with one pole connecting to the second energy source 20 and another pole connecting to the third energy source 30, and the output end of said switch 18 to be connected to a positive output terminal 22, so either energy source 20 or energy source 30 may be selectively electrically connected to output terminal 22 by mechanical switch 18.

Or, as depicted in FIG. 8 and FIG. 9 above said switchable devices 18 may also be replaced by switching devices 28 and 38, comprising two mechanical switches, or electronic switches, preferably magnetic latching relays as illustrated in FIG. 11 and FIG. 12, so positive output terminal 22 may be selectively connected to either energy source 20 or 30, or both.

As FIG. 10 shows, a non-limiting exemplary embodiment of control circuit of magnetic latching relay of the present invention will now be described, the signal line and ground line of control coil of said magnetic latching switch 28 may be connected to said control circuit as shown in FIG. 10, said control circuit may be connected to an energy source, such as a battery, and a switch 58 is utilized to activate and deactivate said magnetic latching switch 28, and a switch 59 to activate and deactivate switch 38 illustrated in FIG. 11 and FIG. 12.

Operations and the methods of charging the above said multiple energy source in accordance with the present disclosure will be described below, according to an embodiment of the present disclosure, above said diode 6 of the charging circuit of the first energy source will keep the first energy source 10 isolated when voltage of electrical system is lower than the voltage of the first energy source, and to exclusively provide current to the starter motor at engine startups, and said switching devices 18 may switch the second energy source 20 to output terminal 22, so electrical appliances of the engine are powered only by energy source 20, and energy source 30 may be left as a backup.

Or, when a switching device 8 is utilized, it may be configured to normally isolate the said first energy source 10 from other energy sources, and to be triggered on and off by a signal sent to the signal line 9 of the switching device 8 in response to various conditions of the engine system, so said charging circuit can be turned closed after the engine is up and running, and turned open when engine is off, so the first energy source 10 will be operatively connected into vehicle's electrical system in parallel by the activation of said switching device 8, recharging of energy source 10 will be achieved by activation/deactivation of the switching device 8, as described herein.

With the above configurations of described non-limiting embodiments, during normal operation of the engine: wherein, before the ignition of the engine is turned to start position and engine is not started up, the diode 6, or the normal open switching device 8 of the charging circuit is open, so to keep the first energy source 10 isolated from the vehicle electrical circuit and energy source 20.

When the ignition switch is turned on, for example, by turning the ignition key to start position, the coils of the cranking motor solenoid are energized by current provided from energy source 20, as the positive terminal 22 of the energy system is only connected to the energy source 20, cranking current to the electric starter motor M of the engine starter is exclusively provided by energy stored in the first energy source 10, there will no more high current output required for the second energy source 20 at engine start-ups, so even with a considerably smaller battery, the engine will still be successfully started.

After the vehicle is started, the engine is up and running, and the alternator of the engine is supplying current to all the electrical appliances of the engine and charging the energy source 20, recharging of the first energy source 10, such as the above said lion-lithium battery pack or super capacitor pack in above described embodiments may be achieved through the diode 6 since the voltage of the electrical system is higher than the voltage of the first energy source 10; or, when switching device 8 is utilized, charging circuit is closed, which is, after activation of switching device 8 when the signal line 9 receives a signal from various parts, switches or controllers, so both the second energy source 20 and first energy source 10 can be charged by the alternator of the engine.

On some vehicles, the alternator is connected to the cable connecting the starter solenoid power supply with the first energy source 10 instead of cable of system electrical appliances, so when engine is up and running, the alternator will charge the first energy source 10 first, and to supply current to the electrical system and other electrical appliances after activation of switching device 8, both the first energy source 10 and second energy source 20 can still be charged by the alternator of the vehicle.

Once the engine is shut, the alternator stops generating current to the electrical system, the voltage drops, the diode 6 will stop charging the first energy source 10, keeping it isolated from the rest of the system again; in other embodiments where a switching device 8 is used, when the above said various parts, switches stop working, or the sensors of controllers detect a vehicle operating parameter below a pre-defined value, determining that the engine has shut off, the signal sent to the signal line 9 of switching device 8 will be cut off, switching device 8 thereby opens again to ensure the first energy source 10 will be isolated from the electrical system and energy sources 20, the sufficiently charged first energy source 10 will remain and maintain its relatively higher voltage since there is no more load on it. As a result, the relatively high voltage of the first energy source 10 will ensure the starting performance of the vehicle is improved, and since the second energy source 20 is prevented from discharging high current, even smaller batteries can last for a long time.

The present invention further provides various methods of controlling switching device 8 of the charging circuit of the first energy source 10, charging of the first energy source 10 may be controlled by activation/deactivation the switching device 8, ideally, activation/deactivation of the above said switching device 8 may be connected to a dedicated signal line or control wire from engine control system, so the charging circuit will be closed when the engine has been started up, and be open again when the engine has shut off, but it is not realistic to modify the engine control system of existing vehicles. So more practically, in some embodiments, above said switching device 8 may comprise a signal line 9 connected to the control coil of said switching device 8, different from U.S. Pat. No. 9,816,475B1, entitled: “System and Method for Maximizing Short-Term Energy Storage a Super capacitor Array for Engine Start Applications”, filed on May 11, 2016, which utilized a DC-DC converter and a control module to charge the super capacitor array prior engine starts with complicated configurations, further different from PCT/US Patent No. 2006/016913, WO 2006/116774, entitle “Hybrid Battery” to Idaho Research Fundation. Inc., in which recharging of the ultra-capacitor requires a converter, a controller and conditional circuit, and control signal is based on the voltage level of the ultra-capacitor, recharging of the energy systems of the present disclosure is much simpler and straight forward: the activation/deactivation of the charging circuit may be controlled by a signal sent to the signal line 9 in response to input from an existing vehicle part, a switching device, or from an independent controller:
1. According to some embodiments of the present disclosure, said signal line 9 of the switching device 8 may be connected to a power supply line or control wire of any device or part of the engine, preferably after a time relay, so as long as said device is on when the engine is started, and is off after the engine has shut off, said switching device 8 will be triggered close or open by engine's running status.
For example, in an embodiment, said signal line 9 of the switching device 8 may be connected to a power supply line, or a control wire of the fuel pump or fuel pump relay of the vehicle, preferably with a timer relay, so only after ignition key is turned on and engine is up for over a predefined period of time, the switching device 8 will be activated to close the charging circuit, and be deactivated when the engine is shut.
2. According to some embodiments of the present invention, said signal line 9 of the switching device 8 may be connected to an independent switching device, said switching device may be turned on or off by change of status of one or more parameter variables of the vehicle.
For example, in some embodiments, said signal line 9 of the switching device 8 of the charging circuit may be connected to a switch, such as a pressure switch, a vacuum pressure switch, a reed switch (a magnetic switch), etc., preferably with a timer relay, so when said switch be turned on by engine oil pressure, vacuum pressure of air intake, magnetic strength generated by a running engine part, etc., said switching device will be closed after a predefined period of time when engine is on, and be opened again when engine is off, so said switching device 8 may be activated on or off by the parameter variables of the vehicle, such parameter variables includes, but not limited to the above said parameter engine oil pressure, vacuum pressure, magnetic strength, etc.
3. According to some embodiments of the present invention, said signal line 9 of the switching device 8 may also be connected to an independent control unit or controller, said controller and may further includes at least one or more sensing devices configured to detect one or more vehicle operating parameters, includes, but not limited to sound, vibration, oil pressure, vacuum pressure, rpm, voltage, charging current of electrical system, etc., said sensing devices may be positioned on, within, proximate to, or even external to the vehicle parts to detect the above said vehicle operating parameters during operation of the vehicle, said controller may be programmable by a user to set and/or customize the system with various parameters or values, and each of the parameters change detected by one or more of sensing devices may be compared to a preset value by the controller, so when one or more monitored operating parameters such as air pressure, oil pressure, vibration levels, voltages, or other ones is below a pre-determined threshold value, which indicating engine is off; said controller keeps switching device 8 open; and when the above mentioned operating parameters equal or above a pre-determined threshold value, thereby indicating the engine is up and running, said controller closes said switching device 8.

In some embodiments, for example, the controller may comprise a vacuum pressure sensor configured to detect the vacuum pressure at the air intake of the engine, supposed a pre-determined value is set to −5 kpa, when the engine is shut, the detected vacuum pressure at the air intake is around zero, thereby indicating the engine is off, thereby the controller keeps said switching device 8 open so to keep the first energy source 10 isolated; after the engine has been started up, the detected vacuum pressure at the air intake will be much higher than −5 kpa, indicating the engine is up, so the controller will activate said switching device 8 so to connect the first energy source 10 into electrical system.

So said controller may be configured independently and operatively actuate/de-actuate the switching device 8, so to independently and operatively control the first energy source 10 for selective and respective connection/isolation to/from other energy sources and electrical system of the engine, thereby allowing the alternator to recharge both energy sources 20 and 10, and to turn the switching device 8 open again when the engine is shut off.

It will be appreciated that the above embodiments are only examples of various methods that may affect or embody the functions of a control device that may activate a switching device such as a solenoid, a relay, a contactor or any similar device, and said device or controller may represent generally any component or combination of components that may control operation of said switching device 8 of the charging circuit, the device or controller may be any device or controller that may keep the switching device 8 open when the engine is turned off; and may close the switching device 8 when one or more vehicle operating parameters satisfied preset thresholds, indicating the engine is running.

According to an embodiment of the present disclosure, the first energy source 10 may comprise a pack of super capacitor cells or a pack of lithium titanate battery cells (LTO), which usually may last considerably longer than ordinary acid-lead batteries, under normal operations on engine start applications, they may typically last longer than the engine itself and need little attention.

But suppose if the second energy source 20 is accidently drained too low to energize the coils of the starter solenoid at engine start-ups, or its performance deteriorates over time, operator just needs to toggle the double pole switch 18 to another pole, as depicted in FIG. 5 and FIG. 6, backup energy source 30 will replace second energy source 20 to supply current to electrical system through terminal 22, so the possibility of being stuck on the road by a dead battery can be avoided, which will be especially valuable for reefer container carriers and long haul drivers as performance stability is critical for them.

As the space is usually very limited on a vehicle, operation of a mechanical switch 18 may sometimes not always easily accessible, so in other embodiments of the present invention, electronic switches, such as magnetic latching relays 28 and 38 may be utilized to replace switchable device 18 according to an embodiment of the present disclosure, as depicted in FIG. 11 and FIG. 12, the signal and ground lines of control coil of said magnetic relay may connect to a power source, such as a battery through a control circuit, by on/off switches 58 and 59, so electrical system battery can be switched to either energy source 20 or energy source 30 respectively, or both. However, above said switches 58 and 59 depicted in FIG. 11 are for illustrative purposes only; they may be replaced by a toggle switch, a rocker switch, or other switches in other embodiments to switch magnetic latching relays 28 and 38.

A great advantage of utilizing magnetic latching relays in said embodiment is that they may provide great flexibility while only consume very little energy, the energy charging a small capacitor at the moment switching on/off status as depicted in FIG. 10, and there is no more energy is required maintaining its on/off position, so it is ideal to be powered by a battery without depleting its energy.

As illustrated in FIG. 5, FIG. 7, FIG. 13 and FIG. 14, above said switching devices 8, 18, 28, 38 and diode 6 of the energy system may be located outside of the housing of said multiple energy source system or may also be located within any of the housing of said energy source system, or both yet in some other embodiments.

FIG. 7 and FIG. 13 show a combination of two energy sources, such as first energy source 10 and third energy source 30 are encapsulated into a single housing in accordance with an embodiment of the present invention, FIG. 14 shows the multiple energy system encapsulated in a single housing in accordance with an embodiment of the present invention. Yet, for convenient replacement of conventional storage batteries, said housing may be easily retrofitted to the electrical system of an existing vehicle without sophisticated modification on existing vehicles, according to some embodiments of the present invention, any combination of above said three energy sources may be enclosed in a half closed housing, or further be packed into a fully closed enclosure or housing with above said switching devices, for example, a combination of all three or any two energy sources may be enclosed into a housing, as illustrated in FIG. 7, FIG. 13 and FIG. 14, it may comprise a first energy source 10 and a third energy source 30, such as a combination of a Li-ion battery and a Pb-acid battery, a super capacitor (ultra-capacitor) pack and a pack of lithium titanate battery cells (LTO), a super capacitor (ultra-capacitor) pack and a Pb-acid battery, or a lithium titanate battery pack with any chemical storage battery.

As shown in FIG. 7 and FIG. 13, at least two positive terminals 2 and 22 and at least one negative terminal are provided on an outer surface of the housing, as illustrated in FIG. 7, for example, the positive terminal of first energy source 10 is connected to an output terminal 2 on the outer surface of the housing by cable 16, and one end of the switching device 8 connected to the positive post of first energy source 10, and another end of the switching device 8 to be connected to the electrical system cable to terminal 22; cable 26 and 36 connect both energy source 20 and energy source 30 to switchable device 18, so either energy source 20 or energy source 30 may be switched to positive output terminal 22; all the negative terminals of energy sources may be connected by cable 3, 33 and 23 to ground 43. And said three terminals are on the upper surface of the housing, however, the number, configuration and the positions of the terminals are non-limiting, the terminals may be placed, for example, in top, front, side or any side of the housing, and the housing may also be susceptible to a variety of implementation-specific variations in size, shape, and placement.

Different from U.S. Pat. No. 9,300,018B2, granted to “Energy Source System Having Multiple Energy Storage Devices”, filed on Mar. 16, 2012, to Thomas M. Watson, Junwei Jiang, Perry M. Wyatt, which comprises two or more energy sources, but utilized two switching devices to selectively control the energy sources to connect and disconnect to a load; and has only one output terminal on the housing; while in exemplary embodiments of the present invention depicted in FIG. 7 and FIG. 13, the energy system also comprises at least two energy sources 10 and 30, more specifically, for example, a combination of a super capacitor pack 10 and a lithium titanate battery pack within a housing, however, on the housing of the energy system comprises at least 2 positive output terminals 2 and 22, the positive terminal of lithium titanate battery pack is coupled to one pole of switch device 18 by cable 36, and the positive terminal of energy source 20 is connected to another pole of switch device 18 by cable 26, suppose energy source 30 is electrically connected to the vehicle's electrical system by switch device 18 and the positive output terminal 22 located on the housing, which to provide power to electrical loads of the vehicle; while the first energy source 10, the super capacitor pack, isolated by switching device 8 of the charging circuit, the positive terminal of the super capacitor pack is coupled to positive terminals 2 on the housing, which is to be connected to the power supply terminal B of engine starter's solenoid of the engine, so to provide brief and high current bursts to the starter motor M each time the solenoid is activated by the ignition switch of the vehicle; and both the negative terminals of the second energy source 20 and the super capacitor pack 10 are connected to a negative terminal located on the housing, which is grounded to the frame of the vehicle.

So when the performance of the electrical system battery, such as energy source 20 is now becoming deteriorated, according to above embodiments of the present invention, switching electrical system battery to energy source 30 may only need to toggle the switching 18 to another pole as depicted in FIG. 5 or to switch 58 off and 59 on as depicted in FIG. 11.

In some embodiments, as shown in FIG. 14, the multiple energy system and all the switches, cables may be encapsulated in a single housing, with at least two positive output terminals and at least one negative terminal on the surface of housing.

In some embodiments, the charging circuit of the above said energy source may optionally include an indicator 14, as illustrated in FIG. 14, which may be a light, an LED, a signal, etc., to display the operational status of charging circuit, such as the on or off status of the switching device 8 and the power source is being recharged.

According to some embodiments of the present invention, said power source may further comprise one or more sensors and a display device 15, said display device 15 is electrically connected to the first energy source, or both to the first and second energy sources and is operatively to display the information collected by said sensor, such as voltage level, state of charge or energy storage level of said power source.

And optionally, a second voltmeter for measuring the level of available electrical power of the system battery may also be included, so it may indicate the power levels of third energy source 30 or second energy source 20 respectively as the operator switches between the above two energy sources as illustrated in FIG. 14.

Although the present description will always refer to switching device 8 of the charging circuit being controlled automatically according to some embodiments of the present invention, furthermore, said charging circuit may further comprise a manual or bypass switch 19 to activate/deactivate the switching device 8, as illustrated in FIG. 14. Obviously, In the embodiments, the manual or bypass switch 19 is generally opened during normal operation of the vehicle, said manual switch 19 may be directly activated by an operator to turn an key, to push a button or via an electronic controller, if activated, the first energy source 10 will be connected with system battery, which may be either second energy source 20 or third energy source 30 in parallel, said manual switch 19 may be used as a safety device, when the voltage of any of the power system is drained too low, it may be charge up by another energy source so to eliminate the possibility of being stuck by a dead battery.

In some embodiments, as illustrated in FIG. 15, above said switch 19, 58 and 59 may be configured on a separate enclosure, or a remote control box 60, optionally with status indicator 14 of switching device 8 and/or energy level displays 15, said enclosure 60 may be installed to a place close to the operator, such as close to, or on the dashboard of the vehicle for easy access to the operator, and remotely connected to the energy system, the vehicle operator can easily control the above said switches from the dashboard of the vehicle.

According to some embodiments of the present invention, as illustrated in FIG. 16, said multiple energy source system may further comprise a solar panel and charging circuits to charge above said three energy sources, said charging circuits may comprise at least three diodes to charge said energy sources respectively and keep the energy sources isolated from each other.

With the above-described configuration, integration of multiple energy sources may provide high power output of super capacitors, long life cycle of lithium titanate batteries, and low cost of lead-acid batteries together.

If said multiple energy source system may be installed on a truck, in this case, because there is no need to change batteries for pre-caution reasons, the operator may take full advantage of each energy source, suppose when the second energy source 20 suddenly failed to power up the coils of starter solenoid at engine start-up due to extremely cold weather or deterioration over time, the operator of the vehicle may simply switch the system battery from the second energy source (Lead-acid battery) 20 to the backup energy source (a lithium titanate battery pack) 30 by turning off switch 58 and turning on switch 59, since energy source 30 is isolated and is always kept fully charged by solar panel 61. And in case when the first energy sources 10 (a super capacitor pack) is discharged too low to crank the DC motor of the starter, the operator may just push the switch or button 19 on the remote 60 to recharge the first energy sources 10 from fully charged energy source 30, which may only take a few seconds because of the low resistance of super capacitor cells. With both fully charged energy sources 10 and 30, the truck may be easily started because of the superb discharging capacity of super capacitor cells and lithium titanate battery even under extremely cold conditions, the operator may continue his trip hassle free with said dead battery energy source 20, and to change the dead battery at his ease later.

According to some embodiments of the invention, it should be noted that the charging circuit may also further comprise various components, devices or circuits for controlling the charging of the energy cells of the above said power systems, such as devices for current limiting, overcharge protection and charge balancing, like resistors, fuses, resettable fuses, circuit breakers, etc., it is especially preferable when the power sources comprise a plurality of super capacitor cells because of the low resistance of super capacitors, high charging current from another power source to the capacitor pack may damage, or even cause fire if the rate of charge is not regulated, the charge rate of the charging circuit into said power systems may be controlled by variable current limiting or resistance devices capable of limiting or regulating the level of current flow to charge the energy source, such as charge-rate-controlling resistors, diodes, DC-DC converters.

According to some embodiments of the present invention, said multiple energy source system may further comprise charging balance circuits, said circuit may be configured to balance the charging of each individual energy cell and the overall voltage to protect the voltage balance of each energy cell, so to avoid some energy cells being charged to a higher or lower voltage than other ones to expand the service life of the energy source.

It should also be noted that in certain implementations, according to the above embodiments of the present invention, a combination of the energy sources discussed in the present disclosure may be physically packaged separately, in half-closed housing, or in a fully closed enclosure, and be installed in the original location of conventional batteries or other locations without major modification or complicated wiring.

And the housing or enclosure of a combination of the energy sources, and charging circuit discussed may be of the same sizes or different sizes than the conventional Pb-acid or other battery types. Further, the housing of the power systems may deviate from conventional battery physical in dimensions for easier installation.

It should be noted although that the configurations, arrangements or methods of the exemplary embodiments of the present invention disclosed herein are primarily described in the context of a vehicular starting system, which may be utilized in motor vehicles like passenger vehicles, trucks, buses, reefer containers, motorcycles, recreational vehicles, the concepts provided herein may also apply to any other type of vehicles and in a wide variety of applications, with or within which an energy storage system is implemented such as, for example, boats, generators, agricultural machineries, industrial vehicles, airplanes, or any other systems.

The present disclosure relates to a multiple energy system, its applications, and methods of controlling the charging of said power source, for this disclosure, some embodiments of the present invention has been shown and described in detail with reference to the foregoing exemplary embodiments, it should be appreciated that the illustrated embodiments are only exemplary, although not explicitly illustrated, it is considered that various parameters and configurations disclosed are as illustrative only, and the subject matter described in the above embodiments are not intended to limit to the exact construction and operation shown and described, various omissions, modifications, substitutions, and changes may be made in various exemplary embodiments without departing from the spirit and the scope of the present inventions, such as factors like types of energy sources, quantities, capacity, size, rated voltages, shapes and physical configurations of the energy cells, and enclosure dimensions, configurations for the electrical system, terminal types and configurations, can be modified and/or adapted according to various applications.

So accordingly, all such modification, alteration, substitution, and improvement in various other embodiments are intended to be included within the scope of the present invention as defined in the appended claims and which are intended to be and are covered by both the disclosure and the appended claims.

In the description of the present invention, It should be understood by those of skill in the art that unless otherwise explicitly specified or limited, all technical and/or scientific terms used in the description are intended to describe certain features of the embodiments only, and shall by no means be restrictive, and the described embodiments are not necessarily to be construed as preferred or advantageous over other embodiments, and examples are illustrative only and are not intended to be limiting.

Accordingly, the terms and expressions have been employed in the foregoing specification such as “comprising” or “including” should be interpreted with same meaning as commonly understood by one of ordinary skill in the art to which the invention pertains, the terms “coupled,” “connected,” and the like as used herein are to be construed broadly, meaning either a fixed connection, a removable connection, or an integral connection can be mechanically or electrically connected; the terms “energy source”, “power source”, “power pack”, “energy system”, “energy cell”, “power cells”, “energy packs”, etc., and other terms such as electrochemical cells, batteries, capacitors, super capacitors, ultra-capacitors and the like may be used inter changeable, and expressions in a singular form include a meaning in both singular and plural form.

There is no intention, in the use of such terms and expressions, of excluding equivalents of the features shown and described or portions thereof, it is recognized that the scope of the invention is defined and limited only by the claims which follow.

What is claimed is:

1. A multiple energy source system for engine start applications, comprising:
A multiple energy source incorporates at least three isolated energy sources in a half closed or a fully closed housing, at least two positive output terminals and one negative terminal are located on the outer surface of the housing of the energy system, the first positive output terminal is connected to the positive end of the first energy source, and the second positive output terminal is connected to either of the other two energy sources through a switching device, and all the negative ends of the energy sources are connected to the at least one negative terminal on the outer surface of the housing;
The switching device may be a double pole switch, the second energy source and the third energy source being selectively connected to the second output terminal by the switch;
A charging circuit, comprising at least one diode, with the output end connected to the first energy source, and the input end connected to the output end of the switching device or the second positive terminal.

2. A multiple energy source system for engine start applications, comprising:
At least three isolated energy sources, the first and the third energy sources being enclosed in an enclosure, with at least two positive output terminals and one negative terminal are located on the outer surface of the enclosure, the first positive output terminal is connected to the positive end of the first energy source, and the second positive output terminal is connected to the positive end of the third energy source, and the second energy source is connected to the third energy source through a switching device, and all the negative cables of the energy sources are connected together;
The switching device may be a double pole switch, the second energy source and the third energy source being selectively connected to the second output terminal by the switch;
A charging circuit, comprising at least one diode, with the output end connected to the first energy source, and the input end connected to the cable connecting switching device and the second positive terminal.

3. A multiple energy source system for engine start applications, comprising:
At least three isolated energy sources, the first energy source includes an output terminal and connected to either of the other energy sources through a charging circuit, the other two energy sources being selectively connected to a second output terminal through a switching device, and all the negative cables of the energy sources are connected together;
The charging circuit, comprising at least one diode, with the output end connected to the first energy source, and the input end connected to the cable connecting the output end of the switching device and the second positive terminal to a load.

4. The energy systems according to claim 1, claim 2 and claim 3, wherein the diode of the charging circuit may be replaced by a switching device, comprising at least one normal open switching device, located within or out of the enclosure of the first energy source, configured to selectively electrically connect and disconnect the first power source to another energy source; said switching device further comprises a control end for external trigger signal and the means for triggering the switching device with said external trigger signal, the activation and deactivation of the charging circuit may be triggered on and off respectively by a signal sent to the control end during normal operation of the engine; including:
Being connected to a power supply line or relay of a device of the vehicle which is on when engine is running and is off when engine is shut, preferably with a timer relay, or
Being connected to a switching device, said switching device is generally opened and closed in response to one or more engine's operating parameters, preferably with a timer relay, or
Being connected to a programmable controller located within or out of the housing of said energy source system, the activation and deactivation of the charging circuit may be triggered on and off respectively by a signal sent to the control end, said controller may selectively store at least one predetermined value programmable by a user, wherein said controller further comprises at least one parameter sensor, said sensor is configured to monitor one or more engine operating parameters, said operating parameter sensor of the controller may include:
A pressure sensor is configured to monitor the pressure level of air intake; or
A pressure sensor is configured to monitor the pressure level engine oil; or
A vibration sensor is configured to detect the vibration of the engine or other parts; or
A voltage sensor is configured to monitor the voltage of the electrical circuit of the system; or
Any other sensor to be configured to detect the operating parameter of the vehicle;
Wherein before the engine is started, said electronic controller opens said switching device of said charging circuit when said level of operating parameters is lower than a predetermined level, indicating the engine is shut; said electronic controller closes the switching device when said level of one or more monitored operating parameters equals or is higher than a predetermined level, indicating the engine is running.

5. The energy systems according to claim 1, claim 2, claim 3 and claim 4, wherein the charging circuit of the first energy source may comprise a DC-DC converter, said DC-DC converter may be configured to convert the voltage of an energy source to different voltages to another energy source.

6. The energy system of claim 4 and claim 5 wherein said means for controlling the said charging circuit comprising the control end of the switching device or DC-DC converter being connected to an on-board computer such as a control module or other engine control system of an engine.

7. The multiple energy systems according to claim 1, claim 2 and claim 3, wherein the double pole switching device may be replaced by at least two independent switching devices.

8. The multiple energy systems according to claim 7, wherein the independent switch devices may be magnetic latching switches.

9. The multiple energy systems according to claim 8, wherein the magnetic latching switches may include control circuits and on/off buttons(switches).

10. The multiple energy systems according to claim 1, claim 2 and claim 3, wherein the energy sources may comprise more than one of a plurality of serially connected energy storage cells, comprising combinations of various battery types like Pb-acid battery, lithium ion battery cells, lithium titanate battery cells (LTO), capacitors, super capacitor (ultra capacitor) cells, and may be configured in serial or in parallel to meet any voltage and current requirement.

11. The multiple energy systems according to claim 1, claim 2 and claim 3, wherein said housing or enclosure of the energy systems may be of different sizes than conventional standard batteries in shapes and sizes and may be located at different locations for easy replacement in vehicles, automobiles, boats, airplanes, generators, etc.

12. The energy system of claim 1, claim 2 and claim 3, further comprising at least one sensor for measuring the level of available electrical power from the first energy source, and optionally more power source sensors for measuring the level of available electrical power from other energy sources, and a display for indicating information collected by said at least one sensor.

13. The power systems of claim 1, claim 2, claim 3 and claim 4, wherein the charging circuit further comprising at least one manual control or switch, said manual control or switch is configured independently and operatively to activate and deactivate the charging circuit.

14. The power systems of claim 1, claim 2, claim 3 and claim 4, wherein the charging circuit may further comprise an indicator to display the operational status of the charging circuit.

15. The energy source system of claim 1, claim 2 and claim 3, further including a remote enclosure for housing said display, and/or said manual switch, and/or indicator, said enclosure being locatable for easy access of the operator.

16. The energy source system of claim 1, claim 2, claim 3 and claim 4, wherein the charging circuit may further comprise a circuit breaker or a fuse.

17. The energy source system of claim 1, claim 2, claim 3 and claim 4, said charging circuit further comprising a current limiting device like a resistor connected within the circuit.

18. The energy source system of claim 1, claim 2, claim 3 and claim 4, wherein the charging circuit may further comprise over-charge protection and charging balancing circuits when charging the energy cells.

19. The energy source systems according to claim 1, claim 2 and claim 3, may further comprise a solar panel and charging circuits to charge the energy sources.
